(19) United States
(12) Patent Application Publication
(10) Pub. No.: US 2007/0271129 A1
(43) Pub. Date: Nov. 22, 2007

(54) INTERACTIVE EMAIL AND CALENDARING SYSTEM

(76) Inventors: Michael D. Dutton, Henderson, NV (US); Diane M. Dutton, Henderson, NV (US)

Correspondence Address: GREENBERG TRAURIG, 3773 HOWARD HUGHES PARKWAY, SUITE 500 NORTH, LAS VEGAS, NV, 89169, US

(21) Appl. No.: 11/737,562

(22) Filed: Apr. 19, 2007

Related U.S. Application Data
(60) Provisional application No. 60/747,648, filed on May 18, 2006.

(51) Int. Cl. G06F 9/46

(52) U.S. Cl. 705/8

(57) ABSTRACT

Described is an interactive email and calendaring system that can automatically create and schedule appointments, verify and confirm such appointments with clients, maintain customer databases, provide financial and statistical reports and generate creative email advertising campaigns.

### CROSS-REFERENCE TO RELATED APPLICATION

This application claims the benefit of Provisional Application No. 60/747,648 filed on May 18, 2006, which is incorporated herein by reference in its entirety for all purposes.

### FIELD OF THE INVENTION

The embodiments of the present invention relate to a system facilitated by computer software, more specifically, to an interactive email and calendaring system that automatically schedules, modifies and notifies users and clients of upcoming appointments and any changes associated therewith.

### BACKGROUND

Whether running a beauty salon, spa, hairdressing studio or tanning salon, a cosmetologist or beautician can appreciate all the complexities associated with scheduling appointments with clients, not to mention the countless hours spent on the phone making and/or correcting scheduling mistakes and changes. In some instances, there can be added expenses in having to hire a receptionist or telephone operator to assist in the scheduling of appointments, which can be a real burden especially for small salons and independent hairdressers. Importantly, numerous other businesses face the same scheduling challenges.

Thus, there exists a need for an interactive email and calendaring system that can automatically schedule appointments, modify appointments as necessary and send reminder notifications to clients with minimal manual input from business personnel.

### SUMMARY

Accordingly, a first embodiment of the present invention provides an interactive email and calendaring system for one or more appointments comprising: one or more databases configured to maintain one or more client profiles; and an email and calendaring application in communication with said one or more databases, said email and calendaring application able to automatically create said one or more appointments based on said one or more client profiles. The one or more appointments can be stored on the one or more databases or on the email and calendaring application. In another embodiment, the email and calendaring application can further modify the one or more appointments based on one or more client feedbacks, the one or more client feedbacks include accepting, cancelling or flagging the one or more appointments.

Other variations, embodiments and features of the present invention will become evident from the following detailed description, drawings and claims.

### BRIEF DESCRIPTION OF THE DRAWINGS

FIG. 1 is a block diagram illustrating an interactive email and calendaring system according to the presently disclosed invention;

FIG. 2 illustrates manually sending an appointment to a client using an interactive email and calendaring application;

FIG. 3 is a block diagram illustrating the process steps of automatically sending an appointment to a client using an interactive email and calendaring application;

FIG. 4 is an illustration of a calendar that can be provided to a client in a notification email; and

FIG. 5 is a block diagram illustrating the process steps of receiving and processing feedback from a client using an interactive email and calendaring application.

### DETAILED DESCRIPTION

It will be appreciated by those of ordinary skill in the art that the invention can be embodied in other specific forms without departing from the spirit or essential character thereof. The presently disclosed embodiments are therefore considered in all respects to be illustrative and not restrictive.

While the embodiments of the present invention are not limited to any particular industry and can be used for any industry wherein appointments are routine, for purposes of brevity and clarity, the detailed description below focuses on the salon industry.

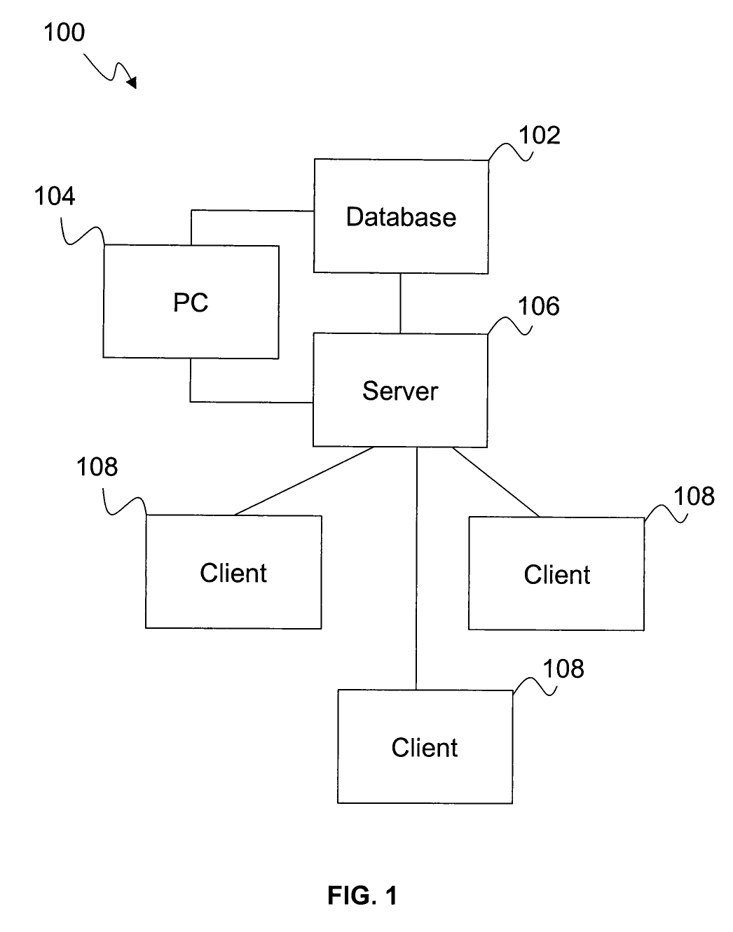

Initial reference is made to FIG. 1 illustrating an interactive email and calendaring system 100 having a database 102 for storing profiles and preferences of existing and potential clients including information such as the client's name, email address, physical address, phone number, date of birth, age, sex, hair color, hair style, hair length, and hair treatment process. The data can further include one or more photos of the client, preferred appointment date/time and preferred interval between visits. The database 102 can also store emails and other electronic documents and be accessed by known systems and methods. Client information stored in other applications, such as Access, Outlook or Excel, or in another database (not shown) can also be retrieved and imported into the database 102. Although only one database 102 is illustrated, it is understood that there can be multiple databases 102 wherein each database 102 can access, share, retrieve, import or export information with other applications, databases and networks, as necessary.

The interactive email and calendaring system 100 also includes a PC 104 facilitating manual access of the information stored in the database 102 by a cosmetologist, beautician, hair stylist, hairdresser, barber, student or any user in need of an electronic calendar for maintaining upcoming events and appointments. The PC 104 can also be used by individuals providing massage and facial therapies at beauty and spa salons. Besides using the PC 104, the database 102 can also be accessed with other types of access terminals or handheld wireless devices such as a PDA or a cellular phone. In some instances, the PC 104 may be integrated into a single system with the database 102.

The interactive email and calendaring system 100 further includes a server 106 for facilitating electronic communication among the database 102, PC 104 and a plurality of client computers 108 via known communication protocols including IMAP, POP3, SMTP and HTTP email protocols. The server 106 can also facilitate communication via other known communication methods and protocols. The systems and methods of implementing and using the server 106 is generally familiar to those skilled in the arts and need not be described in further detail. In some instances, the database 102, PC 104 and server 106 can be integrated into a single system. For privacy reasons, the interactive email and calendaring system 100 may be secured by known systems and methods, including encryption, and passwords.

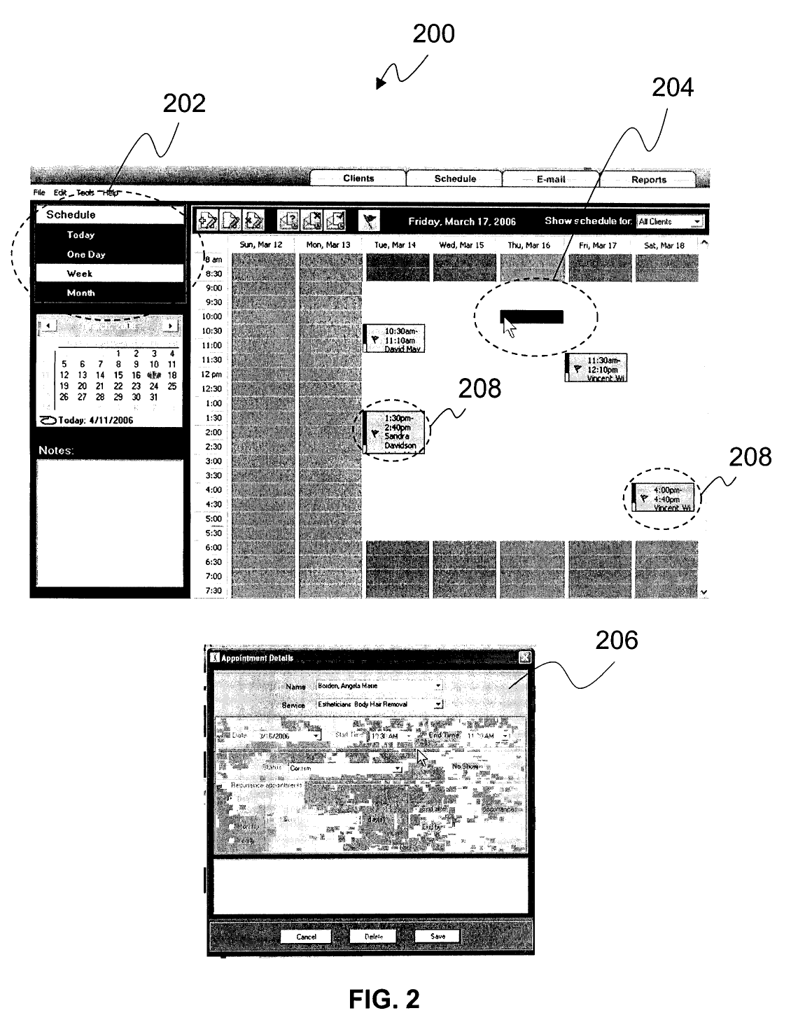

Reference is now made to FIG. 2 illustrating a graphic user interface (GUI) of an interactive email and calendaring application 200, which can be stored on the database 102, PC 104 or server 106. An event or appointment can be manually created by making a selection from a schedule module 202 or by clicking on a date/time slot icon on a calendar 204 resulting in a pop-up window 206. The pop-up window 206 can include information such as the client's name, his or her preferred type of service, date/time of appointment or any other client information previously described. The pop-up window 206 can also include other information relevant to the appointment. A scheduled appointment 208 is subsequently created on the calendar 204 after the user has created or modified the information, saved it and closed the pop-up window 206. To facilitate identification of the scheduled appointment 208, it may be color-coded and/or flagged. Once on the calendar 204, the scheduled appointment 208 can be automatically monitored by the application 200, which is discussed in further detail below.

It is anticipated that the application 200 can accommodate multiple users. In doing so, multiple appointments can take place at the same date/time and on a master calendar (not shown) similar to the calendar 204 shown. Ideally, the master calendar can be sorted and filtered based on a user's preference. For example, the master calendar can be sorted to display the appointments of only one cosmetologist or beautician. Alternatively, the master calendar can display the appointments of all cosmetologists or beauticians for the day, week or month. The application 200 can also include other known search and filter methodologies and preferences.

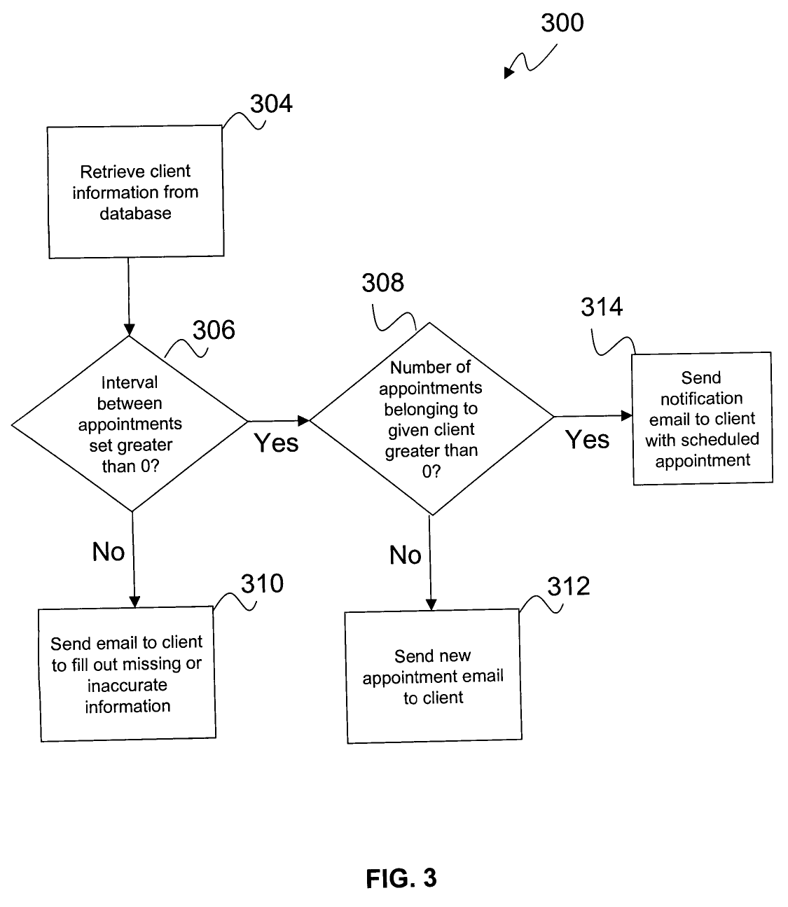

An event or appointment can also be automatically created by the interactive email and calendaring application 200, which is in communication with the plurality of client computers 108. Reference is now made to FIG. 3 illustrating an embodiment of automatically scheduling appointments 300 using the interactive email and calendaring application 200. The automatic appointment process 300 can be initiated by first retrieving client information from the database 304. The client information retrieved from the database 304 can reside on the same database 102 as that described in FIG. 1 or on a different database. Once a client profile has been retrieved from the database 304, the application 200 determines whether the interval between appointments option within the client profile has been set at a value greater than zero 306. If the interval between appointments is not set to a value greater than zero, the application 200 sends a notification email to the client asking the client to fill out the missing, incomplete or inaccurate information 310. The client can respond directly to the notification email 310, which then automatically updates the changes in the client profile within the database 304. Alternatively, the client can also access his or her profile in the database 102 by setting up a username and password as commonly known. The email notification 310 may be periodically sent to the client until the client has filled out the missing, incomplete or inaccurate information. After a pre-determined number of notifications (e.g., maximum of three email notifications), the cosmetologist can manually set the necessary client preference (i.e., manually input a value for the interval between appointments option) by personally calling or emailing the client. Alternatively, the cosmetologist may choose to delete the client record and any associated profile from the database 304.

If the interval between appointments is set to a value greater than zero 306, the application 200 determines whether the number of appointments belonging to the given client is greater than zero 308. In other words, the application 200 next determines whether the client has previously patronized the facility. If the client has not patronized the facility previously (i.e., the number of appointments belonging to the client being zero), the application 200 sends an email to the client asking the client if he or she would like to make a new appointment 312.

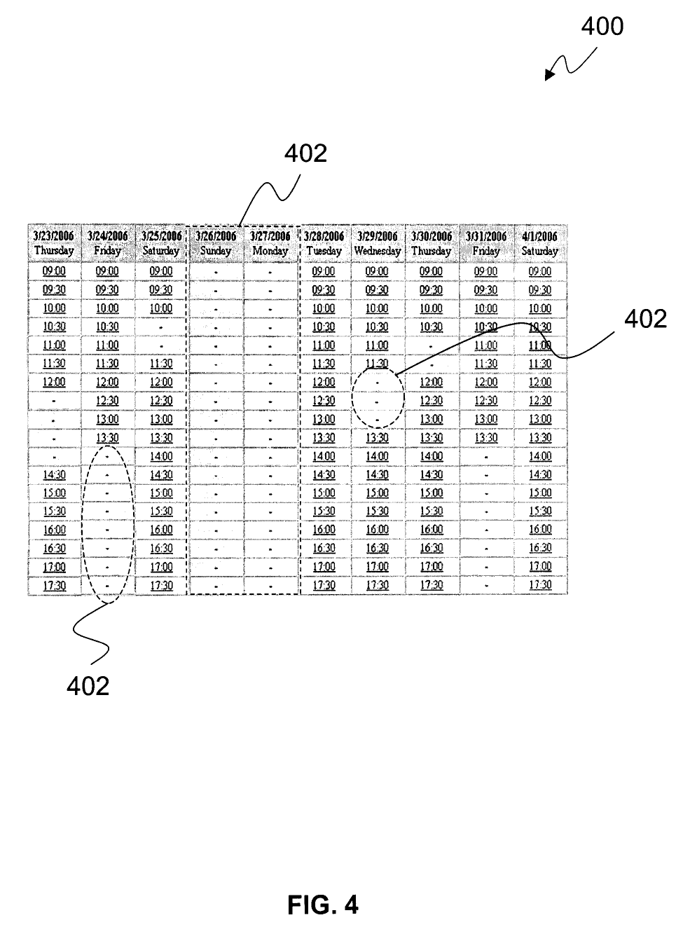

If the client has patronized the facility previously, the application 200 sends a notification email to the client 314 with the client's next scheduled appointment based on the client's preference. Ideally, the notification email 314 is automatically generated and sent to the client based on the client's designated preference of interval between appointments within the client's profile. For example, if the client has visited the facility previously and designated the preferred interval between appointments at 6 weeks, a notification email containing the scheduled appointment 314 is automatically sent to the client with a new appointment 6 weeks after his or her last appointment. In other instances, if the client fails or forgets to designate the interval between appointments or if the interval between appointments is set at zero, an automatic default interval such as 10 or 12 weeks may be used. The notification email 314 can be sent using currently configured protocols such as POP3, IMAP, SMTP, HTTP or other known communication protocols. The notification email 314 may also provide the client with his or her previous treatment history including the date/time of previous visits as well as past treatments (e.g. haircut, hair shampoo, nail polishing, etc.). The notification email 314 may also include a calendar 400 providing alternative appointment dates and times as illustrated in FIG. 4. Although only 10 days are shown in the figure, more or fewer numbers of days may be displayed on the calendar 400. The date/time slots that are not available 402 may be omitted or blocked from the calendar 400. When the client receives the notification email 314, the client need only click on the desired date/time slot on the calendar 400. Once selected, a pop-up window (not shown) similar to that in FIG. 2 may appear and allow the client to enter or edit his or her information including preferred treatments and start/stop time. The pop-up window can also include other information relevant to the appointment. By changing and saving the data in the pop-up window, a scheduled appointment (not shown) similar to that in FIG. 2 may be automatically created in the calendar. Like the scheduled appointment 208 of FIG. 2, once on the calendar, the application 200 monitors and sends periodic notification messages to the client as discussed in further detail below.

The appointment, whether manually scheduled 208 or automatically created 314, remains tentative until the client has provided a response confirming, cancelling or changing the appointment. The client can also flag the appointment should the client have any question. A periodic reminder email from the application 200 may be sent to the client as the tentative appointment 208, 314 approaches. For example, the periodic reminder email may be sent to the client a week or two prior to the scheduled appointment date/time seeking one of the previously described responses. Ideally, more than one periodic reminder email is sent.

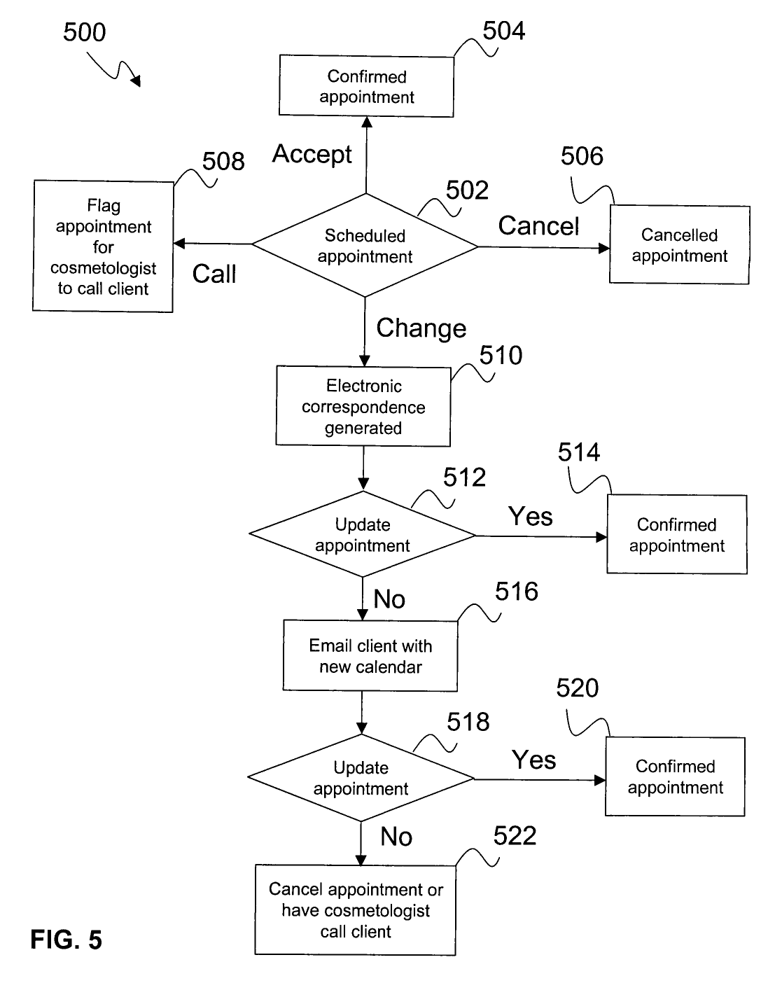

Reference is now made to FIG. 5 illustrating the various methods of receiving and processing feedbacks from the client 500 using the interactive email and calendaring application 200. In a first instance, if the client approves of the date/time slot of the scheduled appointment 502, he or she simply accepts the scheduled appointment 502. In doing so, the status of the appointment changes from scheduled 502 to confirmed 504 on the calendar 204. Different color-codes and/or flags can be used to differentiate confirmed appointments 504 from scheduled appointments 502. The interactive email and calendaring application 200 may continue to automatically monitor the confirmed appointment 504 and send out periodic reminders to the client. These periodic reminders can take place two, three or five days prior to the confirmed appointment 504. The periodic reminders can also be set to go out at any number of days before the confirmed appointment 504. The application 200 may also include a voice module as a means of notifying the program user or cosmetologist of upcoming scheduled 502 or confirmed 504 appointments.

In a second instance, if the client no longer desires an appointment, he or she can simply cancel the scheduled appointment 502. In doing so, the status of the appointment changes from scheduled 502 to cancelled 506 and the appointment is removed from the calendar 204. The date/time slot that is released as a result of the cancellation may now be made available to other clients. The interactive email and calendaring application 200 may also store the record of the cancelled appointment 506 as a marker in order to generate the next notification email 314 based on the client's preference interval between appointments. For example, if the client designates the preferred interval between treatments at 6 weeks but cancels the previously scheduled appointment 502, the application 200 automatically generates another email notification 314 at 6 weeks from the date of the cancelled appointment 506. In other instances, the application 200 can be set to generate an email notification 314 earlier or later than the client's designated interval preference.

In a third instance, if the client is not sure, hesitant or confused about the date/time slot of the scheduled appointment 502 or has other questions or concerns, the client can flag the scheduled appointment 502. In doing so, the status of the appointment changes from scheduled 502 to flag and call 508 on the calendar 204. Different color-codes and/or flags may be used to differentiate flag and call appointments 508 from scheduled appointments 502 and confirmed appointments 504. As a result of the flag and call appointment 508, an automatic reminder may be generated by the interactive email and calendaring application 200 and sent to the cosmetologist providing him or her with the client's name and phone number retrieved from the database 102. The appointment remains in the flag and call state 508 until the cosmetologist has manually resolved the issue. In other instances, the flag and call state 508 can also automatically revert to the scheduled 502 state after a pre-determined period of time.

In a fourth instance, if the client wants to change or modify the date/time slot of the scheduled appointment 502, the client need only click on the preferred date/time slot on a calendar similar to that shown in FIG. 4, which is provided along with the periodic reminder email. After selecting the preferred date/time slot, an electronic correspondence is generated 510 and delivered to the interactive email and calendaring application 200. The generated electronic correspondence 510 can be in the form of an email or other known electronic means via known communication protocols. The electronic correspondence generated 510 causes the application 200 to modify the scheduled appointment 502 that is stored in the database 512 and depicted on the calendar 204. The application 200 then searches the database 102 for an open date/time slot based on the client's new preference.

If the application 200 is able to change the scheduled appointment 502 (i.e., if the client's newly preferred date/time slot is open or available), the status of the appointment changes from scheduled 502 to confirmed 514 on the calendar 204. The application 200 can automatically populate any information necessary for the appointment by transferring the client information from the scheduled appointment 502 to the confirmed appointment 514. Different color-codes and/or flags may be used to differentiate confirmed appointments 514 from scheduled 502 or flagged 508 appointments. A confirmation may be sent to the client acknowledging that the scheduled appointment 502 has been modified and confirmed 514 based on the client's preference. The interactive email and calendaring application 200 then automatically monitors the confirmed appointment 514 and sends out periodic reminders to the client similar to that previously described.

If the application 200 is unable to change the scheduled appointment 502 (i.e., if the client's preferred date/time slot is not open or available), an electronic correspondence such as an email may be generated and sent to the client along with a new calendar 516 similar to that shown in FIG. 4. The new calendar 516 provides the client with a listing of the available date/time slots for rescheduling the appointment. In some instances, instead of having the client choose one date/time slot, the new calendar 516 provides the client with the option of selecting from a plurality of date/time slots (e.g., client can choose up to three date/time slots ranked by order of preference). After the client has indicated the preferred date/time slots, another electronic correspondence is then generated and sent to the application 200. The application 200 repeats the process previously described by searching the database 102 for availability in an attempt to reschedule the client. Like before, if the application 200 finds an available date/time slot based on the client's preference, the status of the appointment changes from scheduled 502 to confirmed 520. Different color-codes and/or flags may be used to differentiate the confirmed appointments 520 from scheduled 502 and flagged 508 appointments. Confirmation emails and automatic monitoring of the confirmed appointment 520 similar to that previously described may be performed by the application 200. If the application 200 is unable to find an open date/time slot based on the client's plurality of preferences, the application 200 can either cancel the schedule appointment 522 or flag the appointment and direct the cosmetologist call the client 522 to make alternative arrangement. Although only two iterations are illustrated, there can be more or fewer iterations based on user preference. Further, it will be appreciated by one skilled in the art that manual input from the cosmetologist can take place and interrupt any scheduling conflict and/or difficulties that may result in changing a scheduled appointment 502.

Any electronic correspondences including emails and electronic messages previously described can be received by the server 106 and parsed according to the sender's email address or the subject of the email (i.e., client is accepting, cancelling, flagging or rescheduling the appointment). The electronic correspondence can also be parsed based on the header, other unique identifiers or size of the correspondence. The email receiving sequence can be initiated manually or automatically by the database 102 (e.g., set default to every five minutes). The incoming electronic correspondences can also be processed using currently configured protocols such as POP3, IMAP, SMTP, HTTP or other known communication protocols. Once parsed, the electronic correspondence can be extracted according to various information fields including without limitation: “from,” “to,” “cc,” “bcc” addresses, mail content, subject, date and time and keywords. The electronic correspondences can also be parsed and extracted by other known methods.

The incoming emails can also be saved to the database 102, PC 104 or server 106. Ideally, the application 200 can receive emails from two groups of senders: clients and others. In filtering or parsing out the two different groups, the sender's email address is compared to the email addresses in the database. If there is a match, then it is an indication that the email is coming from an existing client or an individual who's information is stored in the database 102. If there is no match to any of the email addresses in the database 102, then the incoming email is from another and not the client. The incoming emails from others can be stored in a separate database in order to minimize the amount of emails that the system 100 has to process. With emails from others, the application 200 has the option of adding the unknown email address to the database as a potential client. Alternatively, the application can be combined with a conventional spam filter program to eliminate any potential spam messages. The cosmetologist can also manually process the plurality of emails identified as being from others. Once emails from clients or others are saved, they are processed to reflect their selection choices.

In another embodiment, the interactive email and calendaring system 100 can provide financial and statistical reports (not shown). The types of financial and statistical reports can be customized according to the cosmetologist's fees and schedule and can even produce client statistics, monthly revenue reports and monthly summary revenue reports. The reports can also be sorted based on the client's name, the types of treatment process, treatment dates, and other common known sorting methodologies. In yet another embodiment, the interactive email and calendaring system 100 can be used to generate creative email marketing and advertising campaigns (not shown). By using the client information profiles stored on the database 102, promotional specials, events or activities may be sent via separate email notices to the client. Massive mailing lists may be generated or clients may be individually selected. Clients can also opt out of the marketing and advertising campaigns.

Although the invention has been described in detail with reference to several embodiments, additional variations and modifications exist within the scope and spirit of the invention as described and defined in the following claims.

We claim:

1. An interactive email and calendaring system for one or more appointments comprising:
one or more databases configured to maintain one or more client profiles; and
an email and calendaring application in communication with said one or more databases, said email and calendaring application able to automatically create said one or more appointments based on said one or more client profiles.

2. The system according to claim 1, wherein said one or more client profiles include information such as client's name, email address, physical address, phone number, date of birth, age, sex, hair color, hair style, hair length, hair treatment process, one or more photos of the client, preferred appointment date/time and/or preferred interval between visits.

3. The system according to claim 1, wherein said one or more appointments are stored on said one or more databases or on said email and calendaring application.

4. The system according to claim 1, further comprising said email and calendaring application being able to automatically modify said one or more appointments by searching said one or more databases for available appointment date/time slots.

5. The system according to claim 1, further comprising said email and calendaring application being able to automatically modify said one or more appointments based on client feedback.

6. The system according to claim 5, wherein said client feedback includes accepting, canceling or flagging said one or more appointments.

7. An interactive email and calendaring system for one or more appointments comprising:
one or more databases configured to maintain one or more client profiles and client feedback; and
an email and calendaring application in communication with said one or more databases, said email and calendaring application able to automatically create said one or more appointments based on said one or more client profiles and automatically modify said one or more appointments based on said client feedback.

8. The system according to claim 7, wherein said one or more client profiles include information such as client's name, email address, physical address, phone number, date of birth, age, sex, hair color, hair style, hair length, hair treatment process, one or more photos of the client, preferred appointment date/time and/or preferred interval between visits.

9. The system according to claim 7, wherein said one or more appointments are stored on said one or more databases or on said email and calendaring application.

10. The system according to claim 7, further comprising said email and calendaring application being able to automatically modify said one or more appointments by searching said one or more databases for available appointment date/time slots.

11. The system according to claim 7, wherein said client feedback includes accepting, canceling or flagging said one or more appointments.

12. A method of providing an interactive email and calendaring system for one or more appointments comprising:
configuring one or more databases for storing one or more client profiles; and
providing an email and calendaring application in communication with said one or more databases, said email and calendaring application able to automatically create said one or more appointments based on said one or more client profiles.

13. The method according to claim 12, wherein said one or more client profiles include information such as client's name, email address, physical address, phone number, date of birth, age, sex, hair color, hair style, hair length, hair treatment process, one or more photos of the client, preferred appointment date/time and/or preferred interval between visits.

14. The method according to claim 12, further comprising storing said one or more appointments on said one or more databases or on said email and calendaring application.

15. The method according to claim 12, further comprising said email and calendaring application being able to automatically modify said one or more appointments by searching said one or more databases for available appointment date/time slots.

16. The method according to claim 12, further comprising said email and calendaring application being able to automatically modify said one or more appointments based on client feedback.

17. The method according to claim 16, wherein said client feedback includes accepting, canceling or flagging said one or more appointments.

18. A method of providing an interactive email and calendaring system for one or more appointments comprising:
configuring one or more databases for storing one or more client profiles and client feedback; and
providing an email and calendaring application in communication with said one or more databases, said email and calendaring application able to automatically create said one or more appointments based on said one or more client profiles and automatically modify said one or more appointments based on said client feedback.

19. The method according to claim 18, wherein said one or more client profiles include information such as client's name, email address, physical address, phone number, date of birth, age, sex, hair color, hair style, hair length, hair treatment process, one or more photos of the client, preferred appointment date/time and/or preferred interval between visits.

20. The method according to claim 18, wherein said one or more appointments are stored on said one or more databases or on said email and calendaring application.

21. The method according to claim 18, further comprising said email and calendaring application being able to automatically modify said one or more appointments by searching said one or more databases for available appointment date/time slots.

22. The method according to claim 18, wherein said one or more client feedbacks include accepting, cancelling or flagging said one or more appointments.

23. A computer storage medium for facilitating an interactive email and calendaring system for one or more appointments comprising:
code for configuring one or more databases for storing one or more client profiles; and
code for configuring an email and calendaring application, said application in communication with said one or more databases, said email and calendaring application able to automatically create said one or more appointments based on said one or more client profiles.

24. The computer storage medium according to claim 23, wherein said one or more client profiles include information such as client's name, email address, physical address, phone number, date of birth, age, sex, hair color, hair style, hair length, hair treatment process, one or more photos of the client, preferred appointment date/time and/or preferred interval between visits.

25. The computer storage medium according to claim 23 further comprising code for storing said one or more appointments on said one or more databases or on said email and calendaring application.

26. The computer storage medium according to claim 23, further comprising code for automatically modifying said one or more appointments by searching said one or more databases for available appointment date/time slots.

27. The computer storage medium according to claim 23, further comprising code for automatically modifying said one or more appointments based on client feedback.

28. The computer storage medium according to claim 27, wherein said client feedback includes accepting, canceling or flagging said one or more appointments.

29. A computer programmed to:
provide an interactive email and calendaring system for one or more appointments comprising:
one or more databases for storing one or more client profiles; and
an email and calendaring application in communication with said one or more databases, said email and calendaring application able to automatically create said one or more appointments based on said one or more client profiles.

30. The computer according to claim 29, wherein said one or more client profiles include information such as client's name, email address, physical address, phone number, date of birth, age, sex, hair color, hair style, hair length, hair treatment process, one or more photos of the client, preferred appointment date/time and/or preferred interval between visits.

31. The computer according to claim 29, wherein said one or more appointments are stored on said one or more databases or on said email and calendaring application.

32. The computer according to claim 29, wherein said email and calendaring application is able to automatically modify said one or more appointments by searching said one or more databases for available appointment date/time slots.

33. The computer according to claim 29, wherein said email and calendaring application is able to automatically modify said one or more appointments based on client feedback.

34. The computer according to claim 33, wherein said client feedback includes accepting, canceling or flagging said one or more appointments.
